(19) United States
(12) Patent Application Publication
(10) Pub. No.: US 2019/0133089 A1
(43) Pub. Date: May 9, 2019

(54) BEEKEEPING MEMBER AND METHOD FOR PRODUCING SAME

(71) Applicants: Osaka Gas Chemicals Co., Ltd., Osaka-shi, Osaka (JP); Kunimune Co., Ltd., Osaka (JP)

(72) Inventors: Noriaki Kunimune, Osaka (JP); Masanobu Okita, Osaka-shi, Osaka (JP); Nan Wu, Osaka-shi, Osaka (JP); Koh Kidena, Osaka-shi, Osaka (JP)

(73) Assignees: Osaka Gas Chemicals Co., Ltd., Osaka-shi, Osaka (JP); Kunimune Co., Ltd., Osaka (JP)

(21) Appl. No.: 16/089,781

(22) PCT Filed: Mar. 30, 2017
(86) PCT No.: PCT/JP2017/013281

§ 371 Date: Jan. 14, 2019

(30) Foreign Application Priority Data
Mar. 30, 2016 (JP) 2016-067911

(51) Int. Cl. A01K 51/00; A01M 1/20

(52) U.S. Cl. CPC A01K 51/00; A01M 1/20

(57) ABSTRACT

This invention provides a highly safe beekeeping member that is capable of effectively suppressing the infestation and reproduction of mites, and is excellent in breeding honeybees, and provides a method for producing the beekeeping member.

The beekeeping member of the present invention comprises an anti-mite component comprising platinum particles and metal particles other than platinum particles, whereby the beekeeping member is highly safe, is capable of effectively suppressing the infestation and reproduction of mites, and is excellent in breeding honeybees. The method for producing the beekeeping member comprises the step of immersing a base material in a liquid anti-mite agent containing platinum particles and metal particles other than platinum particles.

### TECHNICAL FIELD

The present invention relates to a beekeeping member and a method for producing the beekeeping member.

### BACKGROUND ART

Heretofore, beekeeping has been conducted involving breeding honeybees and obtaining products derived from honeybees, such as honey. Honeybee breeding may require a honeycomb-shaped man-made beekeeping box called a comb. In such a comb, the reproduction of varroa mites is suppressed by various miticidal measures or mite control measures to prevent varroa mite infection caused by mites parasitic on honeybees. In general, the use of commercially available miticides as an extermination agent to exterminate varroa mites is known to be capable of suppressing the reproduction of varroa mites. Further, a method has recently been proposed for reducing varroa mites by using extermination agents comprising natural components as a miticide or an anti-mite agent, from the viewpoint of safety etc. (Patent Literature (PTL) 1 etc.).

### CITATION LIST

### Patent Literature

PTL 1: JP2006-290809A

### SUMMARY OF INVENTION

### Technical Problem

However, since the extermination agent proposed in PTL 1 comprises natural components, it has a small effect on reducing the reproduction of organisms, such as mites, and there is a concern in that the perfume component in the extermination agent is adsorbed onto the comb.

The present invention has been made in view of the above problems, and an object of the present invention is to provide a highly safe beekeeping member that is capable of effectively suppressing the infestation and reproduction of mites, and is excellent in breeding honeybees, and provide a method for producing the beekeeping member.

### Solution to Problem

The present inventors conducted extensive research to achieve the above object. As a result, the inventors found that the above object can be achieved by incorporating specific metal particles as an anti-mite component. The present invention has been accomplished based on this finding.

Specifically, the present invention includes, for example, the subject matter described in the following items.

Item 1. A beekeeping member comprising an anti-mite component comprising platinum particles and metal particles other than platinum particles.
Item 2. The beekeeping member according to Item 1, wherein the metal particles comprise at least one member selected from the group consisting of silver particles, copper particles, nickel particles, and zinc particles.
Item 3. The beekeeping member according to Item 1 or 2, wherein the metal particles comprise at least one member selected from the group consisting of silver particles and copper particles.
Item 4. The beekeeping member according to any one of Items 1 to 3, wherein the platinum particles and the metal particles have a mean particle size of 0.1 to 1000 nm.
Item 5. The beekeeping member according to any one of Items 1 to 4, wherein the anti-mite component is supported on the surface.
Item 6. A method for producing the beekeeping member of any one of Items 1 to 5, the method comprising the step of immersing a base material in a liquid anti-mite agent containing platinum particles and metal particles other than platinum particles.

### Advantageous Effects of Invention

The beekeeping member according to the present invention is highly safe and is capable of effectively suppressing the infestation and reproduction of mites without inhibiting the growth of honeybees, making excellent breeding of honeybees possible.

The method for producing the beekeeping member of the present invention is suitable for producing the above beekeeping member.

### BRIEF DESCRIPTION OF DRAWINGS

FIG. 1 shows the relationship between rearing time and the number of living varroa mites in Example 1.

FIG. 2 shows the relationship between rearing time and the number of living varroa mites in Example 2.

FIG. 3 shows the results obtained in Example 3. FIG. 3 shows the survival rate of worker bees over time.

### DESCRIPTION OF EMBODIMENTS

Embodiments according to the present invention are described below in detail. In this specification, the expressions “contain,” “comprise,” and “include” encompasses the concepts of “contain,” “essentially consist of,” and “consist of.”

The beekeeping member according to this embodiment comprises an anti-mite component comprising platinum particles and metal particles other than platinum particles. This beekeeping member, which comprises the anti-mite component, is highly safe and is capable of effectively suppressing the infestation and reproduction of mites without inhibiting the growth of honeybees, making excellent breeding of honeybees possible.

The beekeeping member may comprise, as a base material, a member in the form of a beehive, i.e., a honeycomb-shaped member. The type of the base material is not particularly limited. The base material is preferably formed of a resin so that platinum particles and the metal particles are more easily supported.

The resin constituting the base material is not particularly limited. The base material can also be formed of a material other than a resin. Examples of the material include cotton, wool, hemp, and the like.

The shape of the base material is not particularly limited. For example, a known shape generally used as a beekeeping member can be used.

The anti-mite component comprises platinum particles and metal particles other than platinum particles. Below, the “metal particles other than platinum particles” may be simply abbreviated as “the metal particles.”

Platinum particles are particles comprising platinum (Pt). Platinum particles are usually formed of a platinum element and may also comprise an oxide of platinum. Platinum particles may further contain an alloy of platinum and other metal element(s).

The metal particles are not particularly limited. The metal particles are preferably at least one member selected from the group consisting of silver particles, copper particles, nickel particles, and zinc particles. Such metal particles are less toxic and have excellent anti-mite performance, and thus have higher effects of preventing infestation of mite or removing mites.

The metal particles, like platinum particles, are usually formed of at least one metal element selected from the group consisting of silver particles, copper particles, nickel particles, and zinc particles. The metal particles may comprise an oxide of the metal element. The metal particles may further comprise an alloy of the metal element and other metal element(s).

The metal particles may consist only of one of silver particles, copper particles, nickel particles, and zinc particles, or may comprise two or more kinds of these particles.

The metal particles preferably comprise at least one member selected from the group consisting of silver particles and copper particles. In this case, particularly excellent anti-mite performance is achieved, thus achieving further enhanced effects of preventing the infestation of mites or removing mites. The metal particles are particularly preferably silver particles. In this case, highly safe metal particles are used, and the above effects can be achieved at an extremely low concentration; thus, toxicity, irritation, and like properties other anti-mite agents usually have are significantly reduced while achieving excellent anti-mite performance.

The mean particle size of platinum particles and the metal particles is not particularly limited. For example, the particles may be nanoparticles with a particle size of, for example, 0.1 nm or more and 1000 nm or less. In this case, the effect of anti-mite performance is more easily achieved, and the platinum particles and the metal particles can be more easily supported on the base material. Further, a mean particle size of 0.1 nm or more can facilitate atomization of these metals. Additionally, in the case of forming a liquid agent, a mean particle size of 1000 nm or less can more easily inhibit precipitation of the metal particles in the step of forming an aqueous dispersion in which these particles are allowed to be supported on a base material, thus achieving easy handling etc. The mean particle size of platinum particles and the metal particles herein refers to the measurement results obtained by using a zeta potential measuring instrument (Zetasizer Nano ZS90, produced by Malvern Instruments, Ltd.).

The shape of platinum particles and the shape of the metal particles are not particularly limited. Examples include spherical particles, polygonal particles, fibrous particles, needle-like particles, flaky particles, porous particles, and the like. The platinum particles and the metal particles may be in an agglomerated state.

There is no particular limitation on the platinum particle content and the metal particle content in the anti-mite component. From the viewpoint of enhancing the anti-mite performance of the anti-mite component, the platinum particle content and the metal particle content, based on the total mass of the platinum particles and the metal particles defined as 100, are such that the platinum particle content is, for example, 5 or more, preferably 10 or more, more preferably 20 or more, and particularly preferably 30 or more, and is, for example, 95 or less, preferably 90 or less, more preferably 80 or less, and particularly preferably 70 or less.

In the beekeeping member according to this embodiment, the anti-mite component is preferably supported on the surface. The amount of the anti-mite component supported on the base material is not limited, and the amount is, for example, 1 ng/g or more, preferably 10 ng/g or more, and more preferably 100 ng/g or more. The amount of the anti-mite component supported on the base material is 1000000 ng/g or less, more preferably 100000 ng/g or less, and more preferably 10000 ng/g or less. When the amount of the anti-mite component supported on the base material is 1 ng/g or more, a sufficient anti-mite effect can be achieved. When the amount of the anti-mite component supported on the base material is 1000000 ng/g or less, it is economically advantageous. The amount supported on the base material (ng/g) herein refers to the total of the amount of platinum particles supported (ng/g) and the amount of the metal particles supported (ng/g).

The anti-mite component is not necessarily supported on the surface of the base material. For example, the anti-mite component may be incorporated in the base material uniformly or unevenly.

The beekeeping member according to this embodiment may contain other materials as long as the effect of the present invention is not impaired. Examples of other materials include metal particles consisting of components other than the anti-mite component; antimicrobial agents; microbicides; preservatives; antialgal agents; antifungal agents; and the like.

The method for producing the beekeeping member according to this embodiment is not particularly limited.

For example, the beekeeping member can be produced by using an anti-mite agent containing the above anti-mite component and incorporating the anti-mite component into a base material.

When the anti-mite agent is an aqueous solution or a dispersion, the beekeeping member can be produced by the step of immersing a base material in the liquid anti-mite agent containing platinum particles and metal particles other than platinum particles. Below, this step may be abbreviated as “the immersion step.”

The anti-mite agent in this case contains platinum particles and the metal particles, and further optionally contains a solvent. Examples of the solvent include water, lower alcohols (e.g., C₁₋₄ alcohols), and mixed solvents thereof. The type of the solvent is not particularly limited. Further, the method of producing an anti-mite agent is also not particularly limited: an anti-mite agent can be prepared by preparing platinum particles, the metal particles, and medium, and mixing these components in predetermined amounts. To prepare the anti-mite agent, a commercially available mixer or disperser may be appropriately used. In such an anti-mite agent, the total amount of platinum particles and the metal particles may be 0.00001 parts by mass or more, preferably 0.0001 parts by mass or more, and more preferably 0.001 parts by mass or more, and may be, for example, 50 parts by mass or less, preferably 10 parts by mass or less, and more preferably 1 part by mass or less, per 100 parts by mass of the medium. In this case, the mixing ratio of platinum particles and the metal particles (mass of platinum particles:mass of the metal particles), based on the total mass of platinum particles and the metal particles defined as 100, is such that the mass of platinum particles is, for example, 5 or more, preferably 10 or more, more preferably 20 or more, and particularly preferably 30 or more, and is, for example, 95 or less, preferably 90 or less, more preferably 80 or less, and particularly preferably 70 or less.

In the immersion step, the base material may be irradiated with microwaves while being immersed in the anti-mite agent, to thus allow the anti-mite component to be supported on the base material. The microwave irradiation performed accordingly allows for uniform coating in a relatively short time and reinforces the support of the anti-mite component on the base material, whereby the anti-mite component can be supported on the base material without using a binder. This enables the obtained beekeeping member to exhibit better anti-mite effects, and also has another advantage in that metal element elution can be further inhibited because the support of the anti-mite component (platinum particles and the metal particles) on the base material is reinforced.

When microwave irradiation is performed, the irradiation intensity can be 0.005 to 0.1 W/cm³. For the microwave irradiation, for example, a commercially available microwave applicator or microwave oven may be used. When microwave irradiation is performed, heating may be appropriately performed. The microwave irradiation time may be appropriately set according to the microwave irradiation intensity and can be, for example, 0.1 to 60 minutes.

After the immersion step, the base material is removed from the anti-mite agent, and treated by drying etc., to thus obtain a beekeeping member comprising the anti-mite agent.

The method for producing the beekeeping member is not particularly limited to the above method. For example, the beekeeping member can also be produced by using a method comprising spraying the anti-mite agent to a base material; a method comprising applying the anti-mite agent to a base material; a method comprising kneading materials constituting the base material and an anti-mite agent; and the like. In the method comprising spraying the anti-mite agent onto a base material or the method comprising applying the anti-mite agent to a base material, as well, microwave irradiation can be performed as above after the anti-mite agent is sprayed, applied, or the like to form a coating film of the anti-mite agent. In this manner, the anti-mite component is supported on the base material.

### EXAMPLES

The present invention is described below in more detail with reference to Examples. However, the scope of the present invention is not limited to the embodiments of the Examples.

### Preparation Example 1: Preparing Dispersion of Platinum Particles

0.212 g of potassium chloroplatinate (K₂PtCl4) was dissolved in 50 mL of pure water to prepare an aqueous potassium chloroplatinate solution. Separately, 0.129 g of sodium citrate was dissolved in 50 mL of pure water to prepare a 0.01 mol/L aqueous sodium citrate solution, whereas 0.881 g of ascorbic acid was dissolved in 50 mL of pure water to prepare a 0.1 mol/L aqueous ascorbic acid solution. After 50 mL of the aqueous potassium chloroplatinate solution was added to 850 mL of pure water, 50 mL of the 0.01 mol/L aqueous sodium citrate solution and 50 mL of the 0.1 mol/L aqueous ascorbic acid solution were added and stirred at 100 rpm for about 5 minutes to allow a reaction to proceed. Subsequently, an ion-exchange membrane treatment was performed and ionic impurities were removed from the platinum particle dispersion to obtain a colloidal solution containing platinum particles. The platinum particles had a particle size of 130 nm as measured with a zeta potential measuring instrument (Zetasizer Nano ZS90, produced by Malvern Instruments, Ltd.). Further, the platinum particles had a platinum purity of 100% as measured with a TEM/EDS (HITACHI H-7100, accelerating voltage: 100 kV).

The platinum concentration of the dispersion obtained by the above method was confirmed by ICP-MS (Elan DRC II, produced by PerkinElmer, Inc.). The dispersion was further diluted with water to obtain a dispersion having a platinum particle concentration of 100 mg/L (Dispersion 1).

### Preparation Example 2: Preparing Dispersion of Silver Particles

0.157 g of silver nitrate (AgNO₃) was dissolved in 50 mL of pure water to prepare an aqueous silver nitrate solution. Separately, 10 wt % aqueous ammonia was prepared, and 0.881 g of ascorbic acid was dissolved in 50 mL of pure water to prepare a 0.1 mol/L aqueous ascorbic acid solution. After 50 mL of the 0.01 mol/L aqueous silver nitrate solution was added to 900 mL of pure water, the pH was adjusted to pH 11 with 10 wt % aqueous ammonia. Further, 1 mL of the 0.1 mol/L aqueous ascorbic acid solution was added, and the resulting mixture was stirred at 100 rpm for about 5 minutes. Subsequently, an ion-exchange membrane treatment was performed, and ionic impurities were removed from the dispersion of silver particles to obtain a colloidal solution containing silver particles. The particle size as measured with a zeta potential measuring instrument (Zetasizer Nano ZS90, produced by Malvern Instruments, Ltd.) was 130 nm. The silver particles had a silver purity of 100% as measured with a TEM/EDS (HITACHI H-7100, accelerating voltage: 100 kV).

The silver concentration in the dispersion obtained by the above method was confirmed by ICP-MS (Elan DRC II, produced by PerkinElmer Co., Ltd.), and the dispersion was further diluted with water to obtain a dispersion having a silver particle concentration of 100 mg/L (Dispersion 2).

### Preparation Example 3

Dispersion 1 obtained in Preparation Example 1 and Dispersion 2 obtained in Preparation Example 2 were mixed so that the platinum:silver amount became 70:30 (100 ppm in total) to thus obtain an anti-mite agent for use in the Examples below.

### Example 1

A honeycomb produced using PLA (polylactic acid resin) (produced by Kunimune Co., Ltd.) was immersed in the anti-mite agent of Preparation Example 3 (a mixed dispersion of platinum particles and silver particles) to obtain a PLA honeycomb as a beekeeping member on which platinum particles and silver particles were supported. The amount of platinum supported on the obtained beekeeping member was 640 ng/g, and the amount of silver supported was 215 ng/g. The amounts of platinum and silver supported were measured according to the sulfuric acid ashing method. Specifically, (1) after sulfuric acid was added to a sample, carbonization and ashing were performed. (2) The resulting sample was dissolved in aqua regia. (3) After ashing, aqua regia was added and a dissolution treatment was performed. (4) Using Elan DRC II produced by PerkinElmer, Inc., the metal amount of the obtained solution was measured.

The obtained beekeeping member was placed in an acrylic cage (40 cm in width, 10 cm in depth, and 20 cm in height). Five varroa mites were placed in the cage and reared using an incubator (produced by Panasonic Corporation) at 30° C. under a humidity of 70%. Two hours, 4 hours, 6 hours, and 24 hours after the start of rearing, the survival rate of varroa mites was measured. This operation was repeated 6 times to calculate the average survival rate.

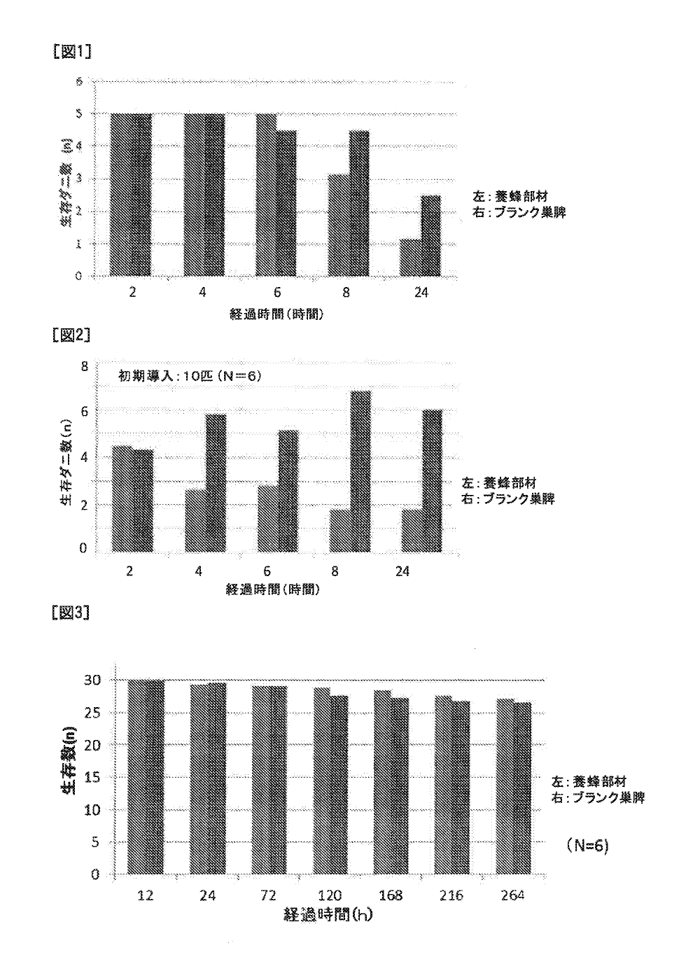

FIG. 1 shows the relationship between the rearing time and the number of living varroa mites. For comparison, FIG. 1 also shows the results of subjecting an untreated PLA honeycomb, i.e., a honeycomb on which neither platinum particles nor silver particles were supported (hereinafter referred to as a “blank comb”) to the same test as that for the beekeeping member. (FIG. 1 illustrates a pair of bar graphs in each elapsed time; the left-side bar graph in each elapsed time shows the number of living mites in the beekeeping member, whereas the right-side bar graph shows the number of living mites in the blank comb.)

These results confirmed that the number of living varroa mites decreased with the lapse of rearing time in the beekeeping member, as compared with that in the blank comb. Accordingly, the honeycomb treated with the miticidal composition comprising platinum particles and silver particles is considered to have miticidal and anti-mite effects.

### Example 2

The beekeeping member obtained in Example 1 and a blank comb were placed in an acrylic cage (40 cm in width, 10 cm in depth, and 20 cm in height). Ten varroa mites were placed in the cage and reared using an incubator (produced by Panasonic Corporation) at 30° C. under a humidity of 70%. Two hours, 4 hours, 6 hours, and 24 hours after the start of rearing, the combs were confirmed as to whether the varroa mites existed. This operation was repeated 6 times to calculate the average number of varroa mites existing in each comb.

FIG. 2 shows the relationship between the rearing time and the number of living varroa mites. (FIG. 2 shows a pair of bar graphs in each elapsed time; the left-side bar graph in each elapsed time shows the number of living mites in the beekeeping member, whereas the right-side bar graph shows the number of living mites in the blank comb.)

These results confirmed that the number of living varroa mites significantly decreased with the lapse of rearing time in the beekeeping member, as compared with that in the blank comb. Accordingly, the honeycomb treated with the miticidal composition comprising platinum particles and silver particles is considered to have a mite repellent effect.

### Example 3

The beekeeping member obtained in Example 1 was placed in an acrylic cage (40 cm in width, 10 cm in depth, and 20 cm in height). Thirty adult worker bees of Apis mellifrera were placed in the cage and bred using an incubator (produced by Panasonic Corporation) at 27° C. under a humidity of 70%. The survival rate of worker bees was measured 12 hours and 24 hours after the start of breeding, and thereafter, at 2-day (48-hour) intervals. This operation was repeated 6 times to evaluate the survival rate of the worker bees. For comparison, a commercially available comb (without anti-mite treatment, hereinafter referred to as a “blank comb”) was also subjected to the same test as that for the beekeeping member above.

FIG. 3 shows the survival rate of worker bees over time. The results reveal that the survival rate of the worker bees in the beekeeping member according to this embodiment is almost the same as that in the general comb (without anti-mite treatment), and that the growth of honeybees was not inhibited.

We claim:

1. A beekeeping member comprising an anti-mite component comprising platinum particles and silver particles.

2-3. (canceled)

4. The beekeeping member according to claim 1, wherein the platinum particles and the silver particles have a mean particle size of 0.1 to 1000 nm.

5. The beekeeping member according to claim 1, wherein the anti-mite component is supported on the surface.

6. A method for producing the beekeeping member of claim 1, the method comprising the step of immersing a base material in a liquid anti-mite agent containing platinum particles and silver particles.

7. The beekeeping member according to claim 4, wherein the anti-mite component is supported on the surface.

8. The method of claim 6, wherein the platinum particles and the silver particles have a mean particle size of 0.1 to 1000 nm.

9. The method of claim 6, wherein the anti-mite component is supported on the surface.

10. The method of claim 8, wherein the anti-mite component is supported on the surface.
